(19) United States
(12) Patent Application Publication
(10) Pub. No.: US 2007/0140311 A1
(43) Pub. Date: Jun. 21, 2007

(54) Method and apparatus for characterizing a glass ribbon

(76) Inventors: Keith Leonard House, Corning, NY (US); Lewis Kirk Klingensmith, Corning, NY (US); Michael Yoshiya Nishimoto, Painted Post, NY (US); Piotr Janusz Wesolowski, Painted Post, NY (US)

Correspondence Address: CORNING INCORPORATED, SP-TI-3-1, CORNING, NY, 14831, US

(21) Appl. No.: 11/314,057

(22) Filed: Dec. 20, 2005

(51) Int. Cl. G01K 1/00; G01K 13/12; C03B 18/18

(52) U.S. Cl. 374/100; 65/29.19; 65/29.21

(57) ABSTRACT

A method and apparatus for measuring the temperature and/or displacement of a glass ribbon formed in a downdraw glass forming process, and measured across width of the ribbon. Temperature and displacement measurements may advantageously be performed simultaneously with a high degree of spatial resolution by a measurement assembly which does not contact the glass ribbon. Temperature measurements may be performed across substantially the entire width of the ribbon. Data developed by the measurement assembly may be used in an automated feedback loop to control the glass ribbon forming conditions.

### BACKGROUND OF THE INVENTION

1. Field of the Invention

This invention is directed to a method of forming glasses, particularly those formed in a fusion downdraw glass making process. More particularly, the apparatus and method according to the present invention provide for the characterization of a glass ribbon wherein an attribute of the ribbon is acquired with a high spatial resolution.

2. Technical Background

Display devices are used in a variety of applications. For example, thin film transistor liquid crystal displays (TFT-LCDs) are used in notebook computers, flat panel desktop monitors, LCD televisions, and Internet and communication devices, to name only a few.

Many display devices, such as TFT-LCD panels and organic light-emitting diode (OLED) panels, are made directly on flat glass sheets (glass substrates). To increase production rates and reduce costs, a typical panel manufacturing process simultaneously produces multiple panels on a single substrate or a sub-piece of a substrate. At various points in such processes, the substrate is divided into parts along cut lines.

Such cutting changes the stress distribution within the glass, specifically, the in-plane stress distribution seen when the glass is vacuumed flat. Even more particularly, the cutting relieves stresses at the cut line such that the cut edge portion may be rendered stress free. Such stress relief in general results in changes in the vacuumed-flat shape of the glass sub-pieces, a phenomenon referred to by display manufacturers as “distortion” or “warp”. Although the amount of shape change is typically quite small, in view of the pixel structures used in modern displays, the distortion resulting from cutting can be large enough to lead to substantial numbers of defective (rejected) displays. Accordingly, the distortion problem is of substantial concern to display manufacturers and specifications regarding allowable distortion as a result of cutting can be as low as 2 microns or less. To meet such small tolerances and potentially smaller tolerances in the future, it is important that substrate manufacturers provide a substrate product that has the lowest possible residual stress.

One method of producing substrate glass for display applications is by an overflow downdraw process. U.S. Pat. Nos. 3,338,696 and 3,682,609 (Dockerty), for example, disclose a fusion downdraw process which includes flowing a molten glass over the edges, or weirs, of a forming wedge, commonly referred to as an isopipe. The molten glass flows over converging forming surfaces of the isopipe, and the separate flows reunite at the apex, or root, where the two converging forming surfaces meet, to form a glass sheet or ribbon. Drawing, or pulling rolls are placed downstream of the isopipe root and capture edge portions of the ribbon to adjust the rate at which the ribbon leaves the isopipe, and thus determine the thickness of the finished sheet. The contacted edge portions are later removed from the finished glass sheet.

As the glass ribbon descends from the root of the isopipe, it cools to form a solid, elastic glass ribbon, which may then be cut to form smaller sheets of glass. This may be accomplished, for example, by scoring the ribbon and subsequently breaking the glass across the score line.

In the case of a downdraw glass forming process, a flowing glass sheet of extraordinary thinness—on the order of 0.7 mm or less—is subjected to potentially large temperature variations across both the width and the length of the sheet. These temperature variations can result in setting up stress in the sheet as it cools from a viscous liquid to an elastic solid. In addition, the scoring process, or other downstream processing, may create movement in the ribbon which is transferred upward to the visco-elastic region of the ribbon, where such movement may result in the freezing-in of residual stress or shape in the glass which may contribute to deformities in the finished product. The visco-elastic region of the glass is typically considered to be a region having a temperature greater than the softening temperature of the glass. Additionally, the glass ribbon may also take on elastic shape or buckling as it cools, due to effects from variable thermal contraction or thickness variability. This can be a source of change of the ribbon shape in the elastic region which propagates to the visco-elastic region and thus can result in frozen-in stress or shape. The elastic region is generally considered the region wherein the temperature of the glass is less than the applicable softening temperature.

To overcome uncontrolled temperature variations in the ribbon which may lead to frozen-in stress or shape, manufacturers using a downdraw method typically enclose the region of the draw where stresses in the glass ribbon are frozen in within a temperature-controlled enclosure. Openings along the length of the enclosure are eliminated to the extent possible to prevent disrupting the temperature distribution within the enclosure. Unfortunately, the need to fully enclose the forming region of the draw machine makes measurements of the glass ribbon difficult at best. Until now, temperature measurements of the glass ribbon have been performed by using thermocouples, or optical pyrometers, located at certain locations along the width of, or along the length of, the enclosure. The number of penetrations into the enclosure are minimized to avoid disruptions to the thermal environment within the enclosure. Unfortunately, the need to minimize the number of penetrations into the enclosure likewise limits access to the ribbon for the pupose of making attribute measurements: attribute measurements can be taken only spottily, limiting the ability to acquire a full picture of the attributes distribution along a width or length of the ribbon. Additionally, thermocouples and optical pyrometers have a relatively large sensing spot (area measured with any single measurement), on the order of 5 cm in some cases, and therefore provide only an average measurement across the sensing spot. They are therefore incapable of accurately discerning temperature gradients which may be hundreds of degrees across relatively short distances, on the order of millimeters or centimeters. For example, temperatures in the bead area of the ribbon may change dramatically as a function of distance, by as much as 150° C. over less than several tens of centimeters. Also, unlike other glass forming processes, notably the so-called float process wherein a glass sheet is formed by floating molten glass on a reservoir of molten metal, in a downdraw glass forming process, such as the fusion process, the glass ribbon is suspended in air and very susceptible to deformation. Contact-type attribute measurements are also unsuitable, particularly for applications where the end use of the glass sheet requires a high degree of optical clarity, such as display applications, as contact with the surface of the glass would destroy the pristine nature of the glass.

Finally, glass for display applications is exceptionally thin, typically less than about 1 mm, and more typically less than 0.7 mm, and is therefore very susceptible to mechanically and thermally-induced deformation. As such, the thermal environment of the glass sheet must be tightly controlled. It would therefore be highly beneficial to measure certain attributes of the ribbon, particularly temperature and/or shape, for example, of a ribbon of glass formed in a downdraw glass forming process as a virtually continuous function of distance by a non-contact method.

### SUMMARY

Embodiments of the present invention provide a method and apparatus for making a glass sheet. More particularly, the method and apparatus may be used to characterize a ribbon of glass formed in a downdraw glass making process by measuring certain attributes of the ribbon. The data developed by using the present invention can be used to control the glass making process, thereby improving the quality of resultant glass sheets cut from the ribbon by reducing the residual stress and/or shape of the ribbon.

Briefly described, one embodiment of the method, among others, can be implemented as described herein. A glass ribbon is formed via a downdraw process. Preferably, the downdraw process is a fusion downdraw method as described, for example, in U.S. Pat. No. 3,338,696. The glass ribbon includes a first side edge and a second side edge, with a width therebetween. At least one attribute of the ribbon is measured at a plurality of points on the ribbon, the measured points preferably having a spatial resolution of less than about 2 mm. The temperature measurement preferably comprises a device (sensor) capable of sensing electromagnetic radiation radiated by the hot glass ribbon. The electromagnetic radiation is preferably in the infrared range; the electromagnetic radiation preferably has a wavelength between about 4.8 μm and about 5.2 μm or between about 5 μm and 14 μm.

Advantageously, the method can facilitate performing attribute measurements across substantially the entire width (from the first side edge to the second side edge) of the glass ribbon, or a portion thereof, with a high degree of spatial resolution.

In accordance with one embodiment, an enclosure is disposed around a viscous and a viscoelastic region of a glass ribbon formed by a downdraw process, there being a slit-shaped opening in a wall of the enclosure. At least one measurement assembly is mounted to the enclosure. The at least one measurement assembly comprises a housing and at least one measurement device adapted to measure through the opening at least one attribute of the glass ribbon.

According to another embodiment, an enclosure is disposed around at least a viscous and a viscoelastic region of a glass ribbon formed by a downdraw process, the enclosure having a slit-shaped opening. At least one measurement assembly is mounted to the enclosure, the at least one measurement assembly comprising a housing, a temperature measuring device and a displacement measuring device for measuring simultaneously a temperature and a displacement of the ribbon, respectively.

In still another embodiment, a method of characterizing a glass ribbon is provided comprising forming a flowing glass ribbon by a downdraw method and measuring simultaneously a temperature and a displacement of a portion of the ribbon in a viscous or a viscoeleastic region of the ribbon.

Measurement of displacement may include a light source which projects a patterned light onto the surface of the glass ribbon, and a detector capable of detecting the patterned light. The detected patterned signal representing the glass deformation may be induced by the glass luminescence, or scattered from the surface of the glass ribbon, or reflected from the glass specular surface. The patterned light is preferably a patterned laser light. The laser light may have a wavelength in the range between about 0.24 μm and about 0.7 μm. The measured portion of the ribbon preferably extends across at least one half of the width of the ribbon.

The invention will be understood more easily and other objects, characteristics, details and advantages thereof will become more clearly apparent in the course of the following explanatory description, which is given, without in any way implying a limitation, with reference to the attached Figures. It is intended that all such additional systems, methods features and advantages be included within this description, be within the scope of the present invention, and be protected by the accompanying claims.

### BRIEF DESCRIPTION OF THE DRAWINGS

FIG. 1 is a perspective view of a downdraw fusion process for drawing a glass ribbon, including an enclosure.

FIG. 2 is a close-up view, in perspective, of a portion of the enclosure of FIG. 1, showing a slit for obtaining measurement data.

FIG. 3 is a top-down view of the enclosure, including a measurement assembly for measuring attributes of the glass ribbon of FIG. 1.

FIG. 4a is a side cross sectional view of the measurement assembly of FIG. 3, attached to the enclosure.

FIG. 4b is a closeup side view of multi-piece shutter doors for closing off the slit.

FIG. 5 is a side cross sectional view of the measurement assembly of FIG. 4 showing an ability to tilt through a predetermined angle α.

FIG. 6 is a top-down view of the enclosure, illustrating the use of a patterned light, and the detection thereof, for determining the displacement of the glass ribbon.

FIG. 7 is a top-down view of the enclosure, depicting the use of two measurement assemblies, disposed in a side-by-side relationship.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

Embodiments of the present invention relate to a method and an apparatus for measuring an attribute or characteristics of a sheet, or ribbon, of glass formed by a downdraw process. Such attributes include, but are not limited to, temperature. Other desirable attributes may include displacement of the ribbon from a vertical reference plane, and birefringence. In particular, the method and apparatus disclosed herein are capable of measuring the desired attribute in fine detail. The spatial resolution of the measurement is preferably less than about 2 mm, more preferably less than about 1 mm. By spatial resolution what is meant is that measurements are taken at a plurality of points across a predetermined region of the ribbon, and the distance between each measurement point—the spatial resolution—is preferably less than a maximum value and limited only by the sampling rate of the instrument. Conventional methods which employ optical pyrometers, for which the area measured during each individual measurement may be many millimeters across, provide an average temperature over the area of the individual measurement. Measurements conducted in accordance with the present invention produce virtually continuous knowledge of the ribbon attribute across the distance measured by scanning the ribbon, and may therefore be capable of providing the information necessary to develop a substantially continuous spatial attribute profile (attribute vs. distance). For example, measurement of temperature in accordance with the present invention can result in determining the actual temperature of the ribbon every 1 or 2 mm across the measured distance, thus facilitating a virtually continuous profile of temperature as a function of distance. The measurements may be taken in a width-wise manner, or in a length-wise manner. Preferably the measurements are taken in a width-wise manner. The attribute is preferably measured across substantially the entire width of the ribbon. By substantially the entire width what is meant is that the measured attribute of the ribbon at a pre-determined vertical position along the length of the ribbon is measured, as the ribbon is drawn, from approximately one side edge to the opposite side edge and at least across the width of the quality region of the ribbon, where the quality region is defined as the region across the ribbon width inside the contact area of pulling rollers (the beads) used to draw the ribbon downward and which eventually becomes part of a glass substrate which may be used for display applications. Of course, as will be appreciated by those skilled in the art, edge-to-edge measurement of temperature is not necessary for operation of the present invention, however desirable it might be for the production of quality glass. For instance, a width segment less than the overall width of the ribbon may be measured using the methods and apparatus of the present invention. For example, measuring the temperature of a region of the ribbon extending from one side edge to the center of the ribbon (i.e. one half of the ribbon) can also provide valuable process information. Narrower width segments are also contemplated, and may include only the bead region of the ribbon. For display applications, the glass ribbon is typically on the order of less than about 1 mm in thickness within the quality areas of the ribbon, and more typically less than about 0.7 mm. Other portions of the ribbon, notably the narrow beads at the edges of the ribbon, may be thicker. Additionally, the beads tend to be cool relative to the rest of the ribbon due to contact with the pulling rolls. Large temperature variation, requiring increased measurement resolution, may therefore occur within relatively short distances across the width of the ribbon—within tens of centimeters of each side edge.

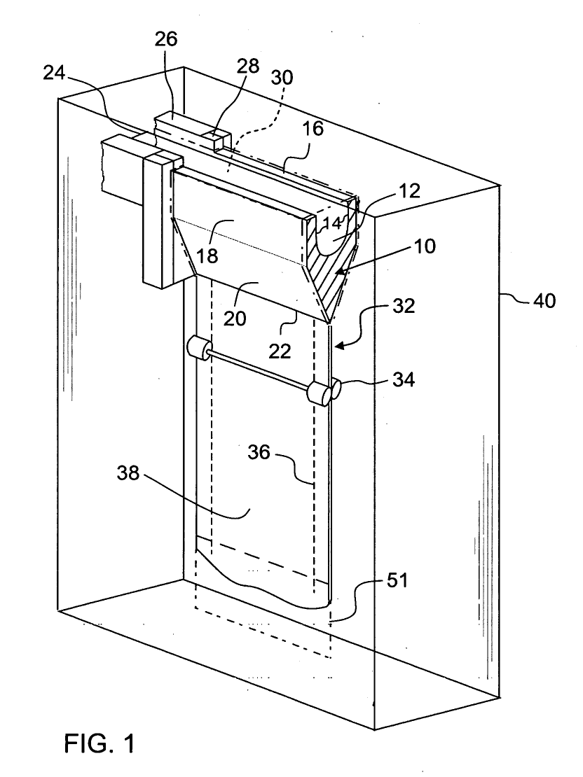

FIG. 1 illustrates a fusion downdraw apparatus comprising forming wedge 10 which includes an upwardly open channel 12 bounded on its longitudinal sides by wall portions 14, which terminate at their upper extent in opposed longitudinally-extending overflow lips or weirs 16. Forming wedge 10 is often referred to as an isopipe. Weirs 16 communicate with opposed outer sheet forming surfaces of wedge member 10. As shown, wedge member 10 is provided with a pair of substantially vertical forming surface portions 18 which communicate with weirs 16, and a pair of downwardly inclined converging surface portions 20 which terminate at a substantially horizontal lower apex or root 22 forming a straight glass draw line.

Molten glass 24 is fed into channel 12 by means of delivery passage 26 communicating with channel 12. The feed into channel 12 may be single ended or, if desired, double ended. A pair of restricting dams 28 are provided above overflow weirs 16 adjacent each end of channel 12 to direct the overflow of the free surface 30 of molten glass 24 over overflow weirs 16 as separate streams, and down opposed forming surface portions 18, 20 to root 22 where the separate streams, shown in chain lines, converge to form a ribbon of virgin-surfaced glass 32.

In the overflow downdraw fusion process, pulling rolls 34 are placed downstream of the root 22 of wedge member 10 and contact side edges 36 (beads) of the ribbon without contacting the interior, quality area 38 of the ribbon. The pulling rolls are used to draw the ribbon, and help set the rate at which the formed ribbon of glass leaves the converging forming surfaces and thus determine the nominal thickness of the finished sheet. Suitable pulling rolls are described, for example, in published U.S. Patent Application No. 2003/0181302.

In a fusion downdraw glass manufacturing apparatus, as a glass ribbon travels from the forming wedge down the drawing portion of the apparatus, the ribbon experiences intricate structural changes, not only in physical dimensions but also on a molecular level. The change from a supple but thick liquid form at, for example, the root of the forming wedge, or isopipe, to a stiff glass ribbon of approximately one half millimeter of thickness is achieved by a carefully chosen temperature field that delicately balances the mechanical and chemical requirements to complete the transformation from a liquid, or viscous state to a solid, or elastic state. Accordingly, as the glass ribbon is formed, it passes through enclosure 40 surrounding the ribbon and which enclosure may also enclose forming wedge member 10. Enclosure 40 is necessarily open at the bottom of the enclosure to allow the glass ribbon to exit the enclosure. Enclosure 40 may be equipped with heating and/or cooling devices (not shown), arranged along at least a portion of the length of enclosure 40 for heating or cooling the glass ribbon. Generally, such heating and cooling is done according to a prescribed schedule such that the glass ribbon is cooled (or heated) at a rate and with a spatial temperature distribution, designed to minimize warping of the ribbon and the freezing in of internal stresses which may cause sheets of glass cut from the ribbon to exhibit warping (i.e. shape). The heaters and/or coolers may be spatially segregated so that certain portions of the glass ribbon are heated or cooled at different rates than other portions of the ribbon as the ribbon descends through enclosure 40. Thus, the ribbon may pass through various zones within the enclosure, each zone having a predetermined temperature distribution.

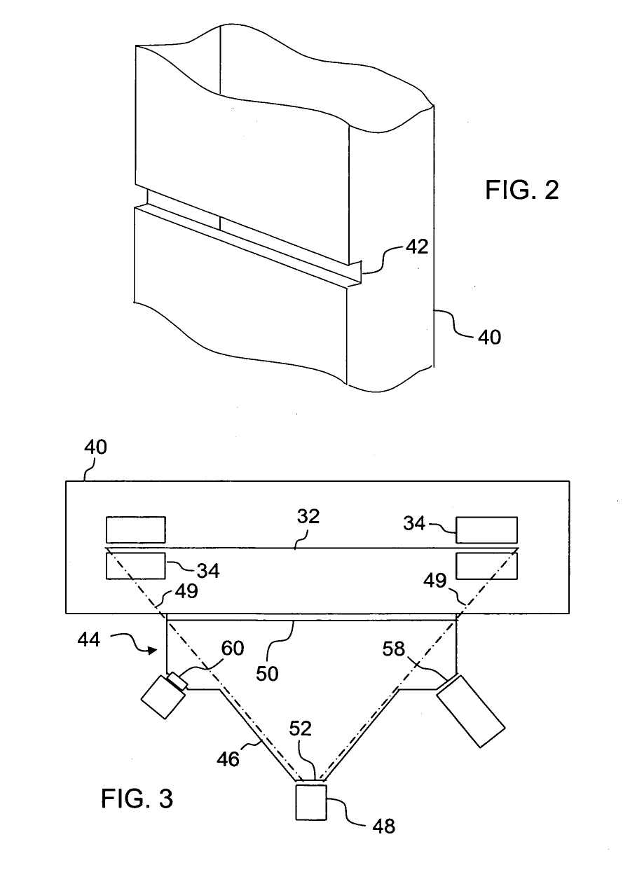

In accordance with an embodiment of the present invention, and as depicted in FIG. 2, enclosure 40 includes at least one slit-shaped opening (hereinafter “slit”) 42 extending across a width of the enclosure. The slit preferably extends across approximately one entire side of enclosure 40. Measurement assembly 44 (FIG. 3) is preferably mounted to the enclosure such that the glass ribbon enclosed by enclosure 40 is optically accessible to measurement assembly 44 through slit 42. By optically accessible what is meant is that there is a clear, optically unobstructed line of sight between each measurement device associated with the measurement assembly and at least a portion of the entire width of the glass ribbon during the period in which a measurement is performed. Preferably, there is an optically unobstructed line of sight between each measurement device associated with the measurement assembly and the entire width of the glass ribbon during the period in which a measurement is performed. As shown in FIG. 3, measurement assembly 44 includes shroud or housing 46 and at least one measurement device for measuring an attribute of the glass ribbon. The interior portion of housing 46 may be temperature controlled, such as by heating or cooling housing 46. Housing 46 may, for example, be heated by resistance heaters (not shown) mounted on or in the housing. The current supplied to the heaters may be controlled through the use of an automatic thermostat such that the temperature within the housing is controlled within a pre-determined range. Cooling may be accomplished by flowing a cooling fluid, such as water, through a water jacket or tubing in or on the housing. Housing 46 may also be insulated with a suitable refractory insulation material.

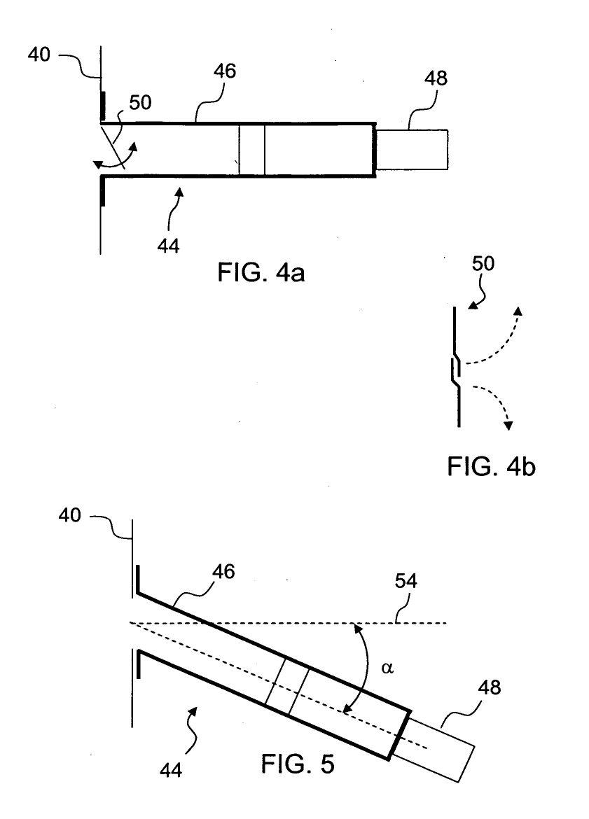

In some embodiments, a movable shutter 50, best seen in FIG. 4a, may also be positioned at slit 42 to separate the measurement assembly from the interior of enclosure 46. Shutter 50 may be used to stabilize the temperature of the glass ribbon within enclosure 40, such as by minimizing the airflow turbulence. That is, as previously explained, it is desirable that the glass ribbon be subjected to a stable, controlled temperature environment within enclosure 40 as the ribbon transitions from a viscous state to an elastic state. Hence, shutter 50 may be thermally controlled such that the temperature of shutter 50 can be regulated and the heat lost by the enclosure with the shutter closed is substantially the same as the heat lost by the enclosure with the shutter open. For example, shutter 50 may be cooled. The shutter may be designed so as to provide minimum storage space requirements for the apparatus. Accordingly, the shutter may be of any appropriate construction: For example, one piece, as illustrated by FIG. 4a; or multi-piece as shown in FIG. 4b.

Measurement assembly 44 accesses enclosure 40 through slit 42, which represents a breach in an otherwise relatively stable thermal environment for the glass ribbon. The presence of a measurement assembly on a side of the slit (enclosure 40) opposite the glass ribbon presents a certain heat extraction capability relative to the environment within the enclosure—the measurement assembly has a certain thermal mass, and can act as a heat sink to the thermal environment in enclosure 40. It may also serve to disrupt airflow within the enclosure, through slit 42, further destabilizing the thermal environment.

There are several methods of minimizing disruption of the thermal environment within enclosure 40. One method is to preheat the measurement assembly to the temperature within the enclosure. Of course, the measurement devices may not be capable of prolonged exposure to such high temperatures, as high as 900° C. in some cases. In another approach, a thermally controlled shutter 50 may be employed to mimic the temperature of the measurement apparatus when the shutter is closed such that the ribbon drawing process can be stabilized under conditions which represent the measurement apparatus. For example, the shutter may be cooled to a temperature equivalent to the average temperature of the measurement assembly. Thus, the ribbon forming process may be stabilized with shutter 50 in a closed position (i.e. slit 42 covered by shutter 50) to isolate the measurement assembly from the high-temperature environment within the enclosure. The temperature of shutter 50 in the closed position is preferably regulated to emulate the heat extraction properties (e.g. thermal mass) of measurement assembly 44. Shutter temperature can be regulated, for example, by including water passages in or on the shutter (not shown). The water flowing through the passages may then be heated and/or cooled by auxiliary equipment located remote from the shutter, and connected to the shutter passages, for example with appropriate tubing. When a measurement is desired, the shutter is opened. Because the ribbon forming process was stabilized under conditions which mimicked an open passage to the measurement assembly through slit 42 while shutter 50 was in a closed position, variations in the thermal environment upon opening of shutter 50 may therefore be minimized.

In some cases it may be desirable to maintain an open optical path between measurement assembly 44 and the interior of enclosure 40 for extended periods of time. For example, it may be desirable to perform measurements of the glass ribbon on an ongoing, uninterrupted basis so as to provide a data source for continuous feedback to the glass-forming process. To facilitate such extended periods, a window may be used across slit 42 or across the shroud assembly 44. Such windows must be optically transparent to the wavelength of measured radiation. Typically, such windows may be manufactured from calcium fluoride (CaF₂), sapphire (Al₂O₃), or zinc sulfide (ZnS). The use of an optically transparent window mitigates the need for a thermally-controlled shutter, since the thermal mass exposed to the environment within enclosure 40, and surrounding glass ribbon 32, is substantially constant. The transparent window may be used separately, or in conjunction with the shutter. Finally, in certain instances, if it is found that the open slit incurs minimal change to the thermal environment within enclosure 40, slit 42 may be maintained open, without the use of windows or shutters to separate the measurement assembly from the environment within the enclosure.

Glass attributes which are of particular importance to measure, monitor, and, when possible control, are the temperature of the glass ribbon and the displacement of the glass ribbon from reference plane 51 (the shape of the ribbon). Ideally, the glass ribbon should descend vertically in a plane passing through the root of the forming wedge. In reality, as previously described, the glass ribbon has a thickness which varies across the width of the ribbon. For example, the thickness of the ribbon may vary from thick beads at the vertical edges of the sheet to a thinner center portion. This varying thickness can result in different portions of the ribbon having a temperature different than other portions of the ribbon, and different cooling rates. Consequently, the spatially varying temperatures of the ribbon, both across the width of the ribbon and along the length of the ribbon, can cause the ribbon to assume a shape which is non-planar. Advantageously, knowledge of this temperature distribution, either across a width of the ribbon (a width segment or substantially the entire width), along the length of the ribbon, or both, would be very useful data with which to control those temperature distributions. The most suitable technologies applicable to the temperature metrology described herein are an infrared linescanner, infrared line-array cameras or 2-dimensional thermography. These technologies offer significant advantages over conventional thermocouple or optical pyrometer technology as a method of determining the ribbon temperature. In particular, infrared process imaging systems, i.e. linescanners or line-array cameras, may beneficially be used. The data obtained from these measurements can be analyzed to produce full cross-sectional temperature profiles of the ribbon temperature.

The energy radiated by the hot glass ribbon is distributed over a band of wavelengths in the electromagnetic spectrum. The intensity and the wavelength distribution of this radiated energy is a function of the temperature of the object being measured. Line scanning or line array infrared systems therefore represent a significant advantage over other point-wise devices, such as thermocouples or optical pyrometers, because they can produce a detailed, spatially resolved map of surface temperature from the radiated temperature within the field of view of the instrument. Such devices are conventionally known and commercially available. For example, a suitable linescanning device is a Model LSP 50ZT7651 infrared (IR) line scanner manufactured by Land Instruments International.

For temperature measurements, it is important that the glass ribbon is optically opaque at the wavelengths at which the measurements are performed in order to eliminate radiation from objects on the opposite side of the ribbon from interfering with the temperature measurements (i.e. that the measurement device not “see” through the glass ribbon and incorporate the temperature of objects on the other side of the ribbon into the ribbon temperature). Preferably, the scanner is capable of sensing radiation in the wavelength range between about 4.8 μm and about 14 μm. For example, a suitable sensing wavelength range is 4.8 μm to 5.2 μm. In the embodiment illustrated in FIG. 3, IR line scanner 48 is positioned at port 52, mid-way across the glass ribbon, and sensing temperature across the width of the ribbon, as indicated by chain lines 49.

In certain other embodiments, shroud 46 may be tiltably mounted to enclosure 40. Shroud 46 may then be rotated, or tilted, vertically such that measurement plane 54 is moved through a predetermined angle α (or a portion thereof), as depicted in FIG. 5, to produce data for not only a single horizontal temperature and/or displacement distribution, but to use multiple horizontal scans to facilitate development of a vertical temperature and/or displacement distribution over a small but useful vertical range. Preferably, the shroud is tilted downward from the normal to the glass ribbon surface at angles up to and including α. For example, the temperature range over which some glasses “freeze” can be less than about 70° C., and for some glasses as small as about 20-30° C. A temperature change of this small magnitude can occur quite rapidly in a downdraw glass forming process, i.e. over a short vertical distance. By including in the measurement assembly an ability to tilt or swivel vertically, this range can be captured with a single device rather than employing several vertically-arrayed banks of measurement assemblies. The measurement assembly captures a horizontal temperature distribution across the width of the ribbon at one vertical location, is tilted a pre-determined amount, then captures another horizontal temperature distribution at a second vertical location. Such horizontal temperature distributions over a series of vertical positionsl along a length of the ribbon can provide data for the compilation of a two-dimensional map of ribbon temperature.

Of course, the use of multiple measurement assemblies located at various locations along the length of the ribbon is also contemplated. For example, measurement assemblies may be vertically stacked at a pre-determined spacing so that the vertical range of each measurement assembly forms a contiguous vertical range. Measurements from each measurement assembly may then be combined to determine an overall vertical distribution over a large distance for the attribute being measured. Alternatively, in other cases the individual ranges need not form a contiguous overall range.

If shutter 50 is not included across slit 42, individual movable shutters disposed over each measurement device may be used to protect the measurement devices from the high temperatures within enclosure 40.

It is within the scope of the present invention that the measurement assembly be mounted to enclosure 40 in a vertical configuration, whereby slit 42 would also be vertical. In this configuration, measurement assembly 44 collects measurement data (e.g. temperature and displacement) along a vertical path at a predetermined horizontal position across the width of the ribbon. In a vertical orientation, measurement instrumentation within measurement assembly 44, for example temperature scanning device 48, would scan in a vertical scanning plane, and may be capable of “tilting” horizontally.

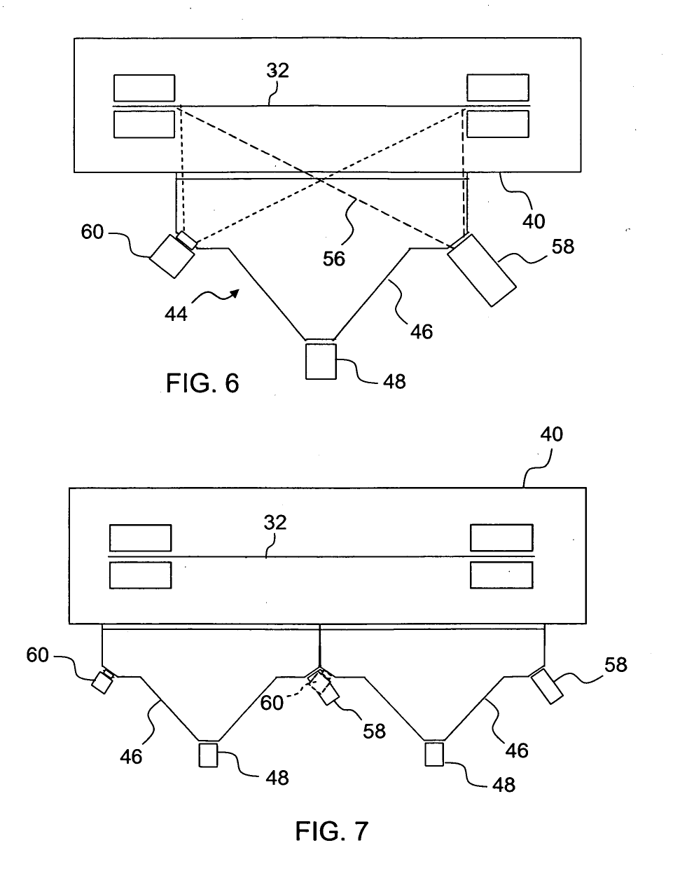

Another useful attribute of glass ribbon 32 for measurement is displacement of the ribbon relative to a predetermined reference plane, typically chosen as vertical plane 51 passing through root 22 of forming wedge 10. Displacement measurements may be made by using conventional imaging methods. For example, testing has been performed by directing a “structured” light (i.e. patterned), typically a laser light, onto the surface of the glass ribbon. A charge coupled detector (CCD) may be used to detect the pattern. Conventional imaging software may then be used to calculate distortion across a width of the glass ribbon surface. In the embodiment depicted in FIG. 6, a structured laser light 56 is projected from laser source 58, and detected by CCD camera 60.

Measurement data obtained from the temperature and/or displacement measurements can be evaluated by a computer (not shown), for example, and may be used in a feedback loop to control heating and/or cooling devices arranged in or around the shroud to effect changes in the temperature profile experienced by the glass ribbon.

In another embodiment of the present invention, several measurement assemblies 44, as shown in FIG. 7, may be deployed side-by-side across the enclosure width, thereby reducing the lateral measurement duty of any one measurement assembly. In this instance, two IR scanning devices 48 are employed, each scanning device adapted to cover one half of the glass ribbon width. Similarly, two lasers 56 for projecting a patterned laser light and two detection devices 58 (e.g. CCD cameras) are used, one pair (a laser and CCD camera) for each half of the ribbon. The individual measurement assemblies of the present embodiment may have any or all of the features described for the previous embodiments.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. For example, although it is preferable, and advantageous, that the measurement assemblies be deployed so as to be able to measure temperature or shape in the viscoelastic region of the glass ribbon, wherein shape and/or stress is frozen into the ribbon, a plurality of measurement assemblies may be deployed at various locations along a substantial length of the ribbon between the pulling rolls and the cut-off location. These locations include the viscous region, the viscoelastic region and the elastic region of the ribbon. Having an array of measurement assemblies deployed along a length of the ribbon means a large-scale two-dimensional temperature and/or shape map can be developed, significantly improving knowledge of the shape and temperature of the ribbon. Such data can lead to detailed knowledge of the condition of the ribbon, and allow more effective management of various process controls (e.g. forming wedge temperature, draw rate, etc.). The measurement assembly disclosed herein need not be limited to measurement of temperature and shape (deflection). Other optically-determined measurements may be employed, such as on-line measurement of birefringence, leading to a direct, on-line measurement of stress in the glass ribbon. Moreover, although the present invention has been described in terms of a fusion downdraw process, the invention is applicable to other downdraw processes, such as a slot draw process (wherein a glass ribbon is drawn from a slot in the bottom of a crucible or other container), or a redraw process (wherein a solid glass preform is melted in a furnace, and a molten glass ribbon is drawn therefrom. All such modifications and variations are intended to be included herein within the scope of this disclosure and the present invention and protected by the following claims.

What is claimed is:

1. An apparatus for characterizing a glass ribbon comprising:
an enclosure disposed around at least a viscous and a viscoelastic region of a glass ribbon having a width and formed by a downdraw process, there being a slit-shaped opening in a wall of the enclosure;
at least one measurement assembly mounted to the enclosure, the at least one measurement assembly comprising a housing and at least one measurement device adapted to measure through the opening at least one attribute of the glass ribbon across at least one half of the width of the ribbon.

2. The apparatus according to claim 1 wherein the at least one measurement assembly is movably mounted to the enclosure.

3. The apparatus according to claim 1 wherein the at least one attribute comprises temperature.

4. The apparatus according to claim 1 wherein the at least one attribute comprises a displacement of the ribbon.

5. The apparatus according to claim 1 wherein the at least one attribute comprises a temperature and a displacement of the ribbon.

6. The apparatus according to claim 1 wherein the measurement assembly is adapted to measure a plurality of ribbon attributes simultaneously.

7. The apparatus according to claim 1 wherein a temperature of the housing interior is controlled.

8. The apparatus according to claim 1 wherein the at least one measurement device detects a patterned light projected onto a surface of the glass ribbon.

9. The apparatus according to claim 1 wherein the at least one measurement assembly comprises a plurality of measurement assemblies.

10. The apparatus according to claim 9 wherein the plurality of measurement assemblies are disposed adjacent each other across the width of the ribbon.

11. The apparatus according to claim 1 further comprising a shutter disposed between the ribbon and the at least one measurement device.

12. An apparatus for characterizing a glass ribbon comprising:
an enclosure disposed around at least a viscous and a viscoelastic region of a glass ribbon formed by a fusion downdraw process, the enclosure having a slit-shaped opening in a side thereof;
at least one measurement assembly mounted to the enclosure, the at least one measurement assembly comprising a housing, a temperature measuring device and a displacement measuring device for measuring simultaneously a temperature, and a displacement of the ribbon, respectively, through the opening.

13. The apparatus according to claim 12 further comprising a movable shutter operable between an open position and a closed position disposed between the slit and the measurement devices.

14. The apparatus according to claim 12 wherein the shutter is cooled.

15. The apparatus according to claim 12 further comprising a window disposed across the opening, the window comprised of calcium fluoride (CaF₂), sapphire (Al₂O₃), zinc sulfide (ZnS), or a combination thereof.

16. The apparatus according to claim 12 wherein a temperature of the housing is controlled.

17. A method of characterizing a glass ribbon comprising:
forming a flowing glass ribbon by a downdraw method;
measuring simultaneously a temperature and a displacement of a portion of the ribbon in a viscous or a viscoeleastic region of the ribbon.

18. The method according to claim 17 wherein the downdraw method is a fusion downdraw method.

19. The method according to claim 17 wherein the measured portion extends across at least one half of a width of the ribbon.

20. The method according to claim 17 wherein the measuring displacement comprises detecting a patterned light projected onto the ribbon.
